(19) United States
(12) Patent Application Publication
(10) Pub. No.: US 2024/0289156 A1
(43) Pub. Date: Aug. 29, 2024

(54) METHODS AND SYSTEMS OF MANAGING HYPERVISOR EFFICIENCY AND UPTIME

(71) Applicant: Red Hat, Inc., Raleigh, NC (US)

(72) Inventors: Yuefen Liu, Beijing (CN); Leigh Griffin, Waterford (IE)

(21) Appl. No.: 18/176,340

(22) Filed: Feb. 28, 2023

(51) Int. Cl. G06F 9/455

(52) U.S. Cl. CPC G06F 9/45558; G06F 2009/45562; G06F 2009/45591

(57) ABSTRACT

Methods, systems, and techniques are disclosed herein for managing hypervisor efficiency and uptime, including a mechanism to regularly test or verify hypervisors and the associated virtual machines. A processing device executes respective diagnostic applications in the hypervisors and collects status reports from the hypervisors. Each of the status reports indicates whether a corresponding hypervisor is operating properly. A first subset of the status reports corresponding to proper operations is grouped together. The hypervisor information of the first subset of the status reports is collected. A second subset of the status reports corresponding to improper operations is grouped together. Respective repair applications are executed in corresponding hypervisors associated with the second subset of the status reports. The processing device generates a report summarizing the hypervisor information of the first subset of the status reports and repairment status of the corresponding hypervisors associated with the second subset of the status reports.

### FIELD

Aspects of the present disclosure relate to hypervisor management.

### BACKGROUND

A hypervisor (or virtual machine monitor) allows multiple virtual machines (e.g., operating systems) to operate on a host computer or a computer network at the same time. The hypervisor enables the multiple virtual machines to share hardware resources while isolates the multiple virtual machines from each other. Cloud computing, data centers, and personal computers may all take advantage of these characteristics of hypervisors.

An operating system (including one that runs on virtual machines monitored by hypervisors) may consume various amount of hardware resources (e.g., processing power, memory use, etc.) For example, Red Hat Enterprise Linux (RHEL) is a Linux-based operating system for use in enterprise environments that supports various hardware architectures. While testing RHEL, especially around the virtualization and entitlement, an important aspect of the testing is to ensure that RHEL agents work on multiple hypervisors. Some hypervisors may be misconfigured or malfunctions before or during the testing operations. A misconfigured or malfunctioning hypervisor may fail to wake-up, failing to support or monitor virtual machines due to insufficient resources (e.g., collectively referred to as hanging or hung), or assigned with hardware resources that will not be used (e.g., an idling hypervisor). Such misconfigured or malfunctioning hypervisors sometimes may only be discovered when a user manually execute a test suite on the hypervisor (or multiple hypervisors on a server farm), which can be laborious and time-consuming to the user.

### SUMMARY

In a general aspect of the present disclosure, an example method is provided of verifying operational status of a multiple hypervisors. The method includes executing, by a processing device, respective diagnostic applications in the multiple hypervisors. The processing device may collect, from the multiple hypervisors, a multiple status reports for the multiple hypervisors. Each of the multiple status reports indicates whether a corresponding hypervisor is operating properly. The processing device may group a first subset of the multiple status reports corresponding to proper operations and collecting hypervisor information of the first subset of the multiple status reports. The processing device may group a second subset of the multiple status reports corresponding to improper operations and executing respective repair applications in corresponding hypervisors associated with the second subset of the multiple status reports. The processing device may generate a report summarizing the hypervisor information of the first subset of the multiple status reports and repairment status of the corresponding hypervisors associated with the second subset of the multiple status reports.

In aspects, the processing device may execute the respective diagnostic applications in the multiple hypervisors by performing at least one of the following. In some cases, the processing device may periodically execute the respective diagnostic applications in the multiple hypervisors at a time interval. In some cases, the processing device may execute, in response to a trigger condition being satisfied, the respective diagnostic applications in the multiple hypervisors. The trigger condition may include detecting, by the processing device, that a virtual machine of the multiple hypervisors has hung.

In some cases, grouping the first subset of the multiple status reports corresponding to proper operations and collecting hypervisor information of the first subset of the multiple status reports may include placing an indicator in each hypervisor corresponding to the first subset of the multiple status reports of proper operations; and printing, with the indicator for each hypervisor in the generated report, the collected hypervisor information of the first subset of the multiple status reports.

In some cases, the processing device may further evaluate status for a multiple virtual machines running in the multiple hypervisors. The processing device may collect, from the multiple virtual machines, a multiple virtual-machine (VM) status reports for the multiple virtual machines. Each of the multiple VM status reports indicates whether a corresponding virtual machine is operating properly. The processing device may group a third subset of the multiple VM status reports corresponding to proper VM operations and collecting VM information of the third subset of the multiple VM status reports.

The processing device may group a fourth subset of the multiple VM status reports corresponding to improper operations and executing respective repair applications in corresponding virtual machines associated with the fourth subset of VM status reports. The processing device may generate in the report a VM summary of the VM information of the third subset of the multiple VM status reports and repairment status of the corresponding virtual machines associated with the fourth subset of VM status reports.

In some cases, the repairment status of the corresponding virtual machines include identifications of irreparable virtual machines. In some cases, the VM summary of the VM information of the third subset of the multiple VM status reports includes resources occupied by properly operating virtual machines of the multiple hypervisors and identifications of the properly operating virtual machines of the multiple hypervisors.

In some cases, the processing device may further disable one or more hypervisors in the multiple hypervisors based on the resources occupied by the properly operating virtual machines. In some cases, the processing device may create one or more hypervisors in the multiple hypervisors based on the resources occupied by the properly operating virtual machines.

In some cases, grouping the second subset of the multiple status reports corresponding to improper operations and executing respective repair applications in corresponding hypervisors associated with the second subset of the multiple status reports includes determining one or more hypervisors having executed respective repair applications to be irreparable; and removing the one or more irreparable hypervisors from the multiple hypervisors.

In aspects, the multiple hypervisors may include hypervisors belonging to various servers.

According to another general aspect, an example apparatus is provided for verifying operational status of a multiple hypervisors. The apparatus includes a memory and a processing device coupled to the memory. The processing device and the memory are to execute, by a processing device, respective diagnostic applications in the multiple hypervisors. The processing device and the memory may collect, from the multiple hypervisors, a multiple status reports for the multiple hypervisors, wherein each of the multiple status reports indicates whether a corresponding hypervisor is operating properly. The processing device and the memory are further to group a first subset of the multiple status reports corresponding to proper operations and collecting hypervisor information of the first subset of the multiple status reports, and group a second subset of the multiple status reports corresponding to improper operations and executing respective repair applications in corresponding hypervisors associated with the second subset of the multiple status reports. The processing device and the memory may then generate a report summarizing the hypervisor information of the first subset of the multiple status reports and repairment status of the corresponding hypervisors associated with the second subset of the multiple status reports.

According to yet another general aspect, an example non-transitory computer-readable storage medium is provided. The non-transitory computer-readable storage medium includes instructions stored thereon that, when executed by a processing device for verifying operational status of a multiple hypervisors, cause the processing device to execute respective diagnostic applications in the multiple hypervisors. The processing device may collect, from the multiple hypervisors, a multiple status reports for the multiple hypervisors, wherein each of the multiple status reports indicates whether a corresponding hypervisor is operating properly. The processing device groups a first subset of the multiple status reports corresponding to proper operations and collecting hypervisor information of the first subset of the multiple status reports and groups a second subset of the multiple status reports corresponding to improper operations and executing respective repair applications in corresponding hypervisors associated with the second subset of the multiple status reports. The processing device may generate a report summarizing the hypervisor information of the first subset of the multiple status reports and repairment status of the corresponding hypervisors associated with the second subset of the multiple status reports.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example host system, in accordance with some embodiments.

FIG. 2 is a block diagram that illustrates an example of implementing hypervisor management at a host system, in accordance with embodiments of the disclosure.

FIG. 3 is a flow diagram of a method of managing hypervisor efficiency and uptime, in accordance with some embodiments.

FIG. 4 illustrates an example block diagram of a hypervisor management system, in accordance with some embodiments.

FIG. 5 is a block diagram of an example apparatus that may perform one or more of the operations described herein, in accordance with some embodiments of the present disclosure.

FIG. 6 illustrates example interfaces for managing hypervisor efficiency and uptime, in accordance with some embodiments of the present disclosure.

Like numerals indicate like elements.

### DETAILED DESCRIPTION

The present disclosure provides methods, systems, and techniques for managing hypervisor efficiency and uptime. For example, to automatically detect or discover misconfigured or malfunctioning hypervisors that contribute to a decrease of operational efficiency, the present disclosure provides a mechanism to regularly test or verify hypervisors and the associated virtual machines (e.g., guests). The hypervisors include the supported and/or available hypervisors in a system or a server farm. The mechanism may be configured or updated based on user preferences, input, and/or system updates. When the mechanism detects an underperforming hypervisor and/or an associated virtual machine, the mechanism may attempt to repair or redeploy the hypervisor and/or the virtual machine.

According to a general aspect of the present disclosure, an example method of verifying operational status of a number of hypervisors is provided herein. The example method includes executing, by a processing device, respective diagnostic applications in the hypervisors. Status reports are then collected from the hypervisors. Each of the status reports indicates whether a corresponding hypervisor is operating properly. A first subset of the status reports corresponding to proper operations is grouped together. The hypervisor information of the first subset of the status reports is collected. A second subset of the status reports corresponding to improper operations is grouped together. Respective repair applications are executed in corresponding hypervisors associated with the second subset of the status reports. The processing device then generates a report summarizing the hypervisor information of the first subset of the status reports and repairment status of the corresponding hypervisors associated with the second subset of the status reports.

As aforementioned, in an enterprise environment that supports various hardware architectures and/or operation systems, many hypervisors may be deployed. As such, the operation status of the various hypervisors and the virtual machines are often unknown until tested or verified. When some hypervisors are misconfigured or malfunction, delayed or untimed testing operations may cause additional delays in a serious of events. For example, a misconfigured or malfunctioning hypervisor may fail to wake-up, failing to support or monitor virtual machines due to insufficient resources (e.g., improper hypervisor operations are collectively referred to as hanging or hung), or assigned with hardware resources that will not be used (e.g., an idling hypervisor). The present disclosure provides methods, systems, and mechanisms for regularly/timely verifying the operation status of hypervisors, and updating (e.g., by repairing or redeploying) the hypervisors to improve the overall operational efficiency and uptime.

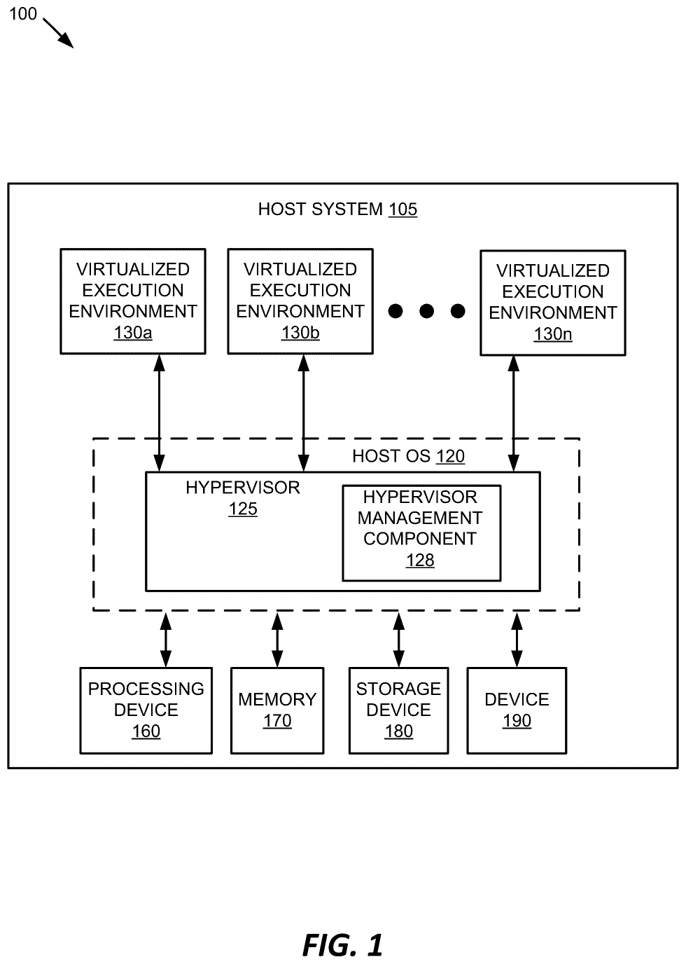

FIG. 1 depicts a high-level component diagram of an illustrative example of a computer system architecture 100, in accordance with one or more aspects of the present disclosure. One skilled in the art will appreciate that other computer system architectures 100 are possible, and that the implementation of a computer system utilizing examples of the present disclosure are not necessarily limited to the specific architecture depicted by FIG. 1.

As shown in FIG. 1, the computer system architecture 100 includes a host system 105. The host system 105 includes various hardware components, such as one or more processing devices 160, memory 170, which may include volatile memory devices (e.g., random access memory (RAM)), non-volatile memory devices (e.g., flash memory), and/or other types of memory devices, a storage device 180 (e.g., one or more magnetic hard disk drives, a Peripheral Component Interconnect (PCI) solid state drive, a Redundant Array of Independent Disks (RAID) system, a network attached storage (NAS) array, etc.), and one or more devices 190 (e.g., a PCI device, network interface controller (NIC), a video card, an I/O device, etc.).

In certain implementations, the memory 170 may be non-uniform access (NUMA), such that memory access time depends on the memory location relative to the processing device 160. It should be noted that although, for simplicity, a single processing device 160, storage device 180, and device 190 are depicted in FIG. 1, other embodiments of the host system 105 may include a plurality of processing devices, storage devices, and devices. The host system 105 may be a server (farm/cluster), a mainframe, a workstation, a personal computer (PC), a mobile phone, a palm-sized computing device, etc.

The host system 105 may additionally include one or more virtualized execution environments 130a-n and the host operating system (OS) 120. The virtualized execution environments 130a-n may each be a virtual machine (VM), a container, or other execution environment. A VM may be a software implementation of a machine that executes programs as though the VM were an actual physical machine. A VM may include containers that each acts as an isolated execution environment for different services of applications, as previously described. Additionally, containers may be deployed without a VM. The host OS 120 manages the hardware resources of the computer system and provides functions such as inter-process communication, scheduling, memory management, and so forth.

The host OS 120 may include a hypervisor 125 (which may also be known as a virtual machine monitor (VMM)), which provides a virtual operating platform for virtualized execution environments 130a-n and manages their execution. Though referred to as a hypervisor, the hypervisor 125 may include any manager or monitor that allocate common hardware resources to one or more virtual machines. As shown in FIG. 1, the hypervisor 125 may manage system resources, including access to physical processing devices (e.g., processors, CPUs, etc.), physical memory (e.g., RAM), storage device (e.g., HDDs, SSDs), and/or other devices (e.g., sound cards, video cards, etc.). The hypervisor 125, though typically implemented in software, may emulate and export a bare machine interface to higher level software in the form of virtual processors and guest memory.

Higher level software may include a standard or real-time OS, may be a highly stripped down operating environment with limited operating system functionality, and/or may not include traditional OS facilities, etc. The hypervisor 125 may present other software (i.e., “guest” software) the abstraction of one or more VMs that provide the same or different abstractions to various guest software (e.g., guest operating system, guest applications). The hypervisor 125 may include a hypervisor management component 128. It should be noted that in some alternative implementations, the hypervisor 125 may be external to the host OS 120, rather than embedded within the host OS 120, or may replace the host OS 120.

The hypervisor management component 128 may manage hypervisor efficiency and uptime to facilitate the communication between the virtualized execution environment (e.g., containers) 130a-n. The hypervisor management component 128 may execute respective diagnostic applications in various hypervisors. The hypervisor management component 128 may collect multiple status reports for the various hypervisors. The status reports indicate whether a corresponding hypervisor is operating properly. The hypervisor management component 128 may group a first subset of the status reports corresponding to proper operations and collecting hypervisor information of the first subset of the status reports. The hypervisor management component 128 may group a second subset of the status reports corresponding to improper operations and execute respective repair applications in corresponding hypervisors associated with the second subset of the status reports. The hypervisor management component 128 then generates a report summarizing the hypervisor information of the first subset of the status reports and repairment status of the corresponding hypervisors associated with the second subset of status reports. In some cases, the hypervisor management component 128 includes a processing device for performing the operations mentioned. In some cases, the hypervisor management component 128 uses the processing device 160 to perform the operations mentioned.

According to aspects of the present disclosure, the hypervisor management component 128 may execute the respective diagnostic applications in the various hypervisors by periodically executing the respective diagnostic applications in the various hypervisors at a time interval. In other aspects, the hypervisor management component 128 may execute, in response to a trigger condition being satisfied, the respective diagnostic applications in the various hypervisors. The trigger condition includes detecting that a virtual machine of the various hypervisors has hung. For example, a hung hypervisor (or the virtual machines therein) is not responsive to testing applications of the test suite. In some cases, a hung hypervisor may respond with a message indicating error or failure of operation.

In some aspects, the hypervisor management component 128 further evaluates status for multiple virtual machines running in the various hypervisors. The hypervisor management component 128 collects virtual-machine (VM) status reports from the multiple virtual machines. For example, each of the VM status reports indicates whether a corresponding virtual machine is operating properly. The hypervisor management component 128 may group a third subset of the VM status reports corresponding to proper VM operations and collect VM information of the third subset of the VM status reports.

The hypervisor management component 128 may group a fourth subset of the VM status reports corresponding to improper operations and execute respective repair applications in corresponding virtual machines associated with the fourth subset of VM status reports. The hypervisor management component 128 then generates, in the report, a VM summary of the VM information of the third subset of the VM status reports and repairment status of the corresponding virtual machines associated with the fourth subset of VM status reports. The reports on the operational conditions of the virtual machines may be used to determine or improve hardware resource allocation by the various hypervisors.

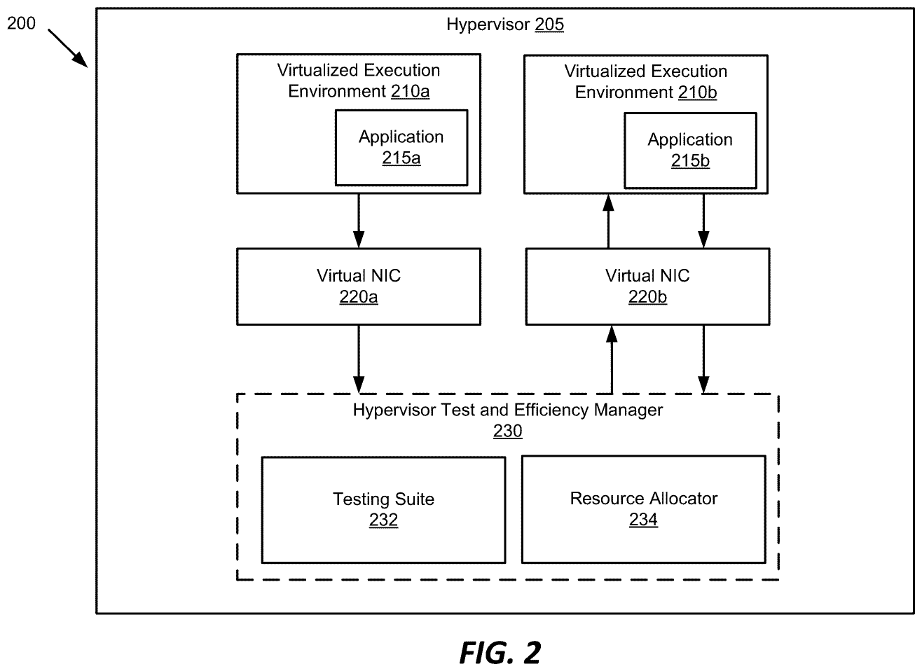

FIG. 2 is a block diagram that illustrates an example of automatic regular testing of hypervisors in a hypervisor of a host system 200 in accordance with embodiments of the disclosure. The host system 200 may include a hypervisor 205 and virtualized execution environments 210a and 210b, as previously described at FIG. 1. The virtualized execution environment 210a may be a VM or a container that acts as an execution environment for a first application 215a. Although referred to as an application, the application 215a may also be a service executing within a container. The virtualized execution environment 210b may be a VM or a container that acts as an execution environment for a second application 215b. Although referred to as an application, the application 215b may also be a service executing within a container.

In some examples, the first application of the virtualized execution environment 210a and the second application of the virtualized execution environment 210b may use different programming languages. The virtualized execution environment 210a and virtualized execution environment 210b may be bridged to various network segments via virtual network interface controller (NIC) 220a and virtual NIC 220b, respectively. The virtual NICs 220a and 220b may each be abstract virtualized representations of a physical NIC of host system 200. The packets sent from and/or received by containers 210a and 210b may be transmitted via their respective virtual NICs (e.g., virtual NICs 220a, b).

The host system 200 may include a hypervisor test and efficiency manager 230 that is stored in the host system memory (e.g., memory 170 and/or storage device 180 of FIG. 1). In some examples, the testing suite 232 of the hypervisor test and efficiency manager 230 may be stored in an area of hypervisor memory accessible by hypervisor 205. The hypervisor test and efficiency manager 230 may include the testing suite 232, the retransmission counters 234, and other information, such as network addresses, for virtualized execution environments 210a and 210b that may be used by hypervisor 205 for sending and re-sending of packets between virtualized execution environments 210a and 210b.

In one example, the testing suite 232 may include logic used by the hypervisor 205 to determine whether the hypervisor 205 is operating properly, such as having sufficient hardware resource allocation to support the virtual machines in operation, as well as identifying an unexpected hang or operation error. The hypervisor 205 may use the testing suite 232 to determine whether configuration updates for the hypervisor 205 is needed or required for optimizing the hardware resource allocation (e.g., either insufficient or underutilized). The hypervisor 205 may use the testing suite 232 to determine that the hypervisor 205 is healthy (and thus no further reconfiguration is recommended) or that the hypervisor 205 is underperforming, so that the hypervisor 205 may be repaired, reconfigured, or shutdown (or replaced).

The testing suite 232 may include test programs or applications that verify the operation conditions of the hypervisor 205. For example, in some embodiments, the test suite 232 includes queries for invoking responses from the hypervisor 205. The responses indicate an operation condition of the hypervisor 205. In some embodiments, the test suite 232 includes queries for the virtualized execution environments 210a and 210b to invoke responses therefrom. The responses indicate an operation condition of the virtualized execution environments 210a and 210b. In some cases, when one correct response is provided by the virtualized execution environment 210a or 210b (or the respective application 215a or 215b therein), the hypervisor test and efficiency manager 230 may consider the hypervisor 205 healthy (or without misconfiguration or malfunction).

The hypervisor test and efficiency manager 230 may use the resource allocator 234 to reconfigure or update the hypervisor 205, such as upon detecting misconfigurations in the virtualized execution environment 210a or 210b. In some cases, the resource allocator 234 may assign additional resources (e.g., CPU or memory allocation) when the hypervisor test and efficiency manager 230 determines that insufficient resource has been allocated to the virtualized execution environment 210a or 210b (and that the underperformance has been identified by running the testing suite 232 therein. In some cases, the resource allocator 234 may reduce resource allocation in the virtualized execution environment 210a or 210b when the allocated resources are underutilized by the hypervisor 205.

In some examples, the hypervisor 205 may receive the hypervisor test and efficiency manager 230 from a container orchestration system that provides service mesh logic that includes one or more network policies that may be used by hypervisor 205 for implementing a service mesh. In some examples, the hypervisor test and efficiency manager 230 may be received from virtualized execution environment 210a (i.e., a container or VM). In some examples, the hypervisor test and efficiency manager 230 may be received from the application 215a. In one example, the hypervisor test and efficiency manager 230 may be received from other sources.

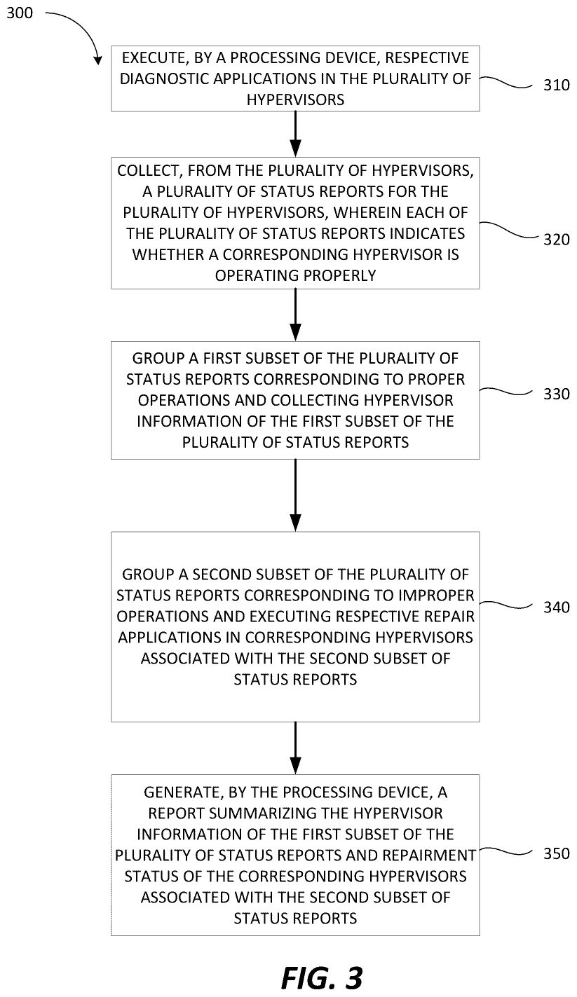

FIG. 3 is a flow diagram of a method 300 of automatic regular testing of hypervisors in a hypervisor, in accordance with some embodiments. Method 300 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 300 may be performed by the hypervisor management component 128 or the processing device 160 of the hypervisor 125 of FIG. 1, or the hypervisor 205 of FIG. 2.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

Method 300 begins at block 310, where the processing logic executes respective diagnostic applications in multiple hypervisors. For example, the processing logic causes various hypervisors (e.g., of different types or modes, such as ESX, HYPERV, KUBEVIRT, AHV, LIBVIRT, RHEVM, XEN) to execute respective diagnostic applications to verify whether the hypervisors are operating properly.

At block 320, the processing logic collects from the hypervisors status reports for the various hypervisors. Each of the status reports indicates a result of the executing of the diagnostic applications (e.g., whether a corresponding hypervisor is operating properly).

At block 330, the processing logic groups a first subset of the status reports corresponding to proper operations and collects hypervisor information of the first subset of the status reports.

At block 340, the processing logic groups a second subset of the status reports corresponding to improper operations and executes respective repair applications in corresponding hypervisors associated with the second subset of the status reports.

At block 350, the processing logic generates a report summarizing the hypervisor information of the first subset of the status reports and repairment status of the corresponding hypervisors associated with the second subset of status reports.

In aspects, the processing logic executes the respective diagnostic applications in the hypervisors periodically at a time interval. For example, the time interval may include a default value or be configured by a user. The periodic or regular execution of the diagnostic applications allows for automatic evaluation of the performance of various hypervisors. The processing logic may also execute the respective diagnostic applications in response to a trigger condition being satisfied. For example, the trigger condition includes detecting, by the processing device, that a virtual machine of the hypervisors has hung.

In some cases, the processing logic may group the first subset of the multiple status reports corresponding to proper operations and collecting hypervisor information of the first subset of the status reports by placing an indicator in each hypervisor corresponding to the first subset of the status reports of proper operations. The processing logic may print, with the indicator for each hypervisor in the generated report, the collected hypervisor information of the first subset of the status reports.

In aspects, the processing logic evaluates status for a virtual machines running in the hypervisors and collects, from the virtual machines, a virtual-machine (VM) status reports for the virtual machines. Each of the VM status reports indicates whether a corresponding virtual machine is operating properly. The processing logic groups a third subset of the VM status reports corresponding to proper VM operations and collecting VM information of the third subset of the VM status reports. The processing logic groups a fourth subset of the VM status reports corresponding to improper operations and executes respective repair applications in corresponding virtual machines associated with the fourth subset of VM status reports. The processing logic then generates a VM summary of the VM information of the third subset of the VM status reports and repairment status of the corresponding virtual machines associated with the fourth subset of VM status reports.

In some cases, the repairment status of the corresponding virtual machines may include identifications of irreparable virtual machines. The VM summary of the VM information of the third subset of the VM status reports may include resources occupied by properly operating virtual machines of the hypervisors, and identifications of the properly operating virtual machines of the hypervisors. Based on the results of the diagnostic applications, the processing logic may disable one or more hypervisors in the hypervisors based on the resources occupied by the properly operating virtual machines, or create one or more hypervisors in the hypervisors based on the resources occupied by the properly operating virtual machines.

In aspects, the processing logic determines one or more hypervisors having executed respective repair applications to be irreparable (or that the repair application cannot resolve the misconfiguration or malfunctioning issues involved). In response to such a determination, the one or more irreparable hypervisors are removed from the various hypervisors being regularly verified. In some cases, the removal includes retrieving hardware resources assigned to the irreparable hypervisors and reassigning the retrieved hardware resources to other or new hypervisors.

In aspects, the various hypervisors that are automatically managed, tested, or verified by the processing logic may include hypervisors that belong to various servers. For example, one of the various hypervisors may be a VMware ESXi (or ESX), another one of the various hypervisors may be Microsoft® Hyper-V. Yet another one of the various hypervisors may be KubeVirt (a virtual machine management add-on for Kubenetes). Another one of the various hypervisors may be Acropolis Hypervisor (AHV). Some or all of the different modes or types of the hypervisors may be selected or included for the automatic testing or verification discussed herein.

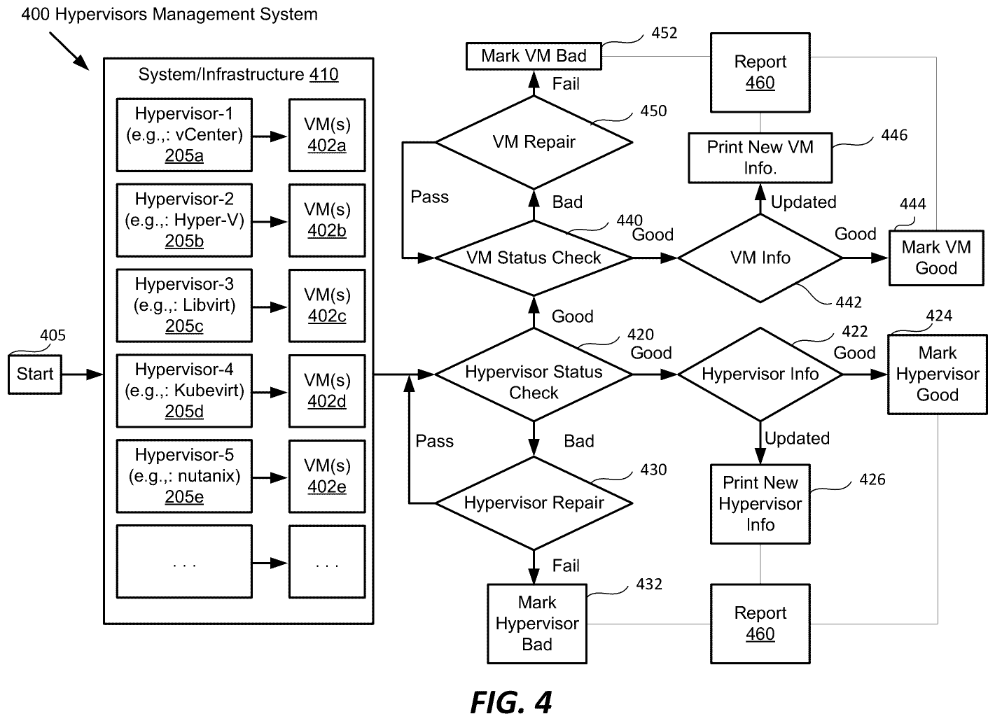

FIG. 4 illustrates an example block diagram of a hypervisors management system 400. As shown, the hypervisors management system 400 includes a start module 405 and a system/infrastructure 410. The start module 405 may include a timer for periodically providing the system/infrastructure 410 an instruction to perform hypervisor operation testing or operation. The start module 405 may also include one or more triggering responses for triggering a testing procedure in the system/infrastructure 410 upon detecting hardware changes or performance warnings from the multiple hypervisors in the infrastructure 410. In some cases, the start module 405 includes a user interface for receiving a command or instruction from a user to initiate the hypervisor testing procedure.

The system/infrastructure 410 includes various hypervisors 205a, 205b, . . . 205e, and others. Each hypervisor manages one or more virtual machines 402a, 402b, . . . 402e, and others. During operation, the start module 405 initiates or triggers the hypervisor status check 420, which executes respective test suites in the hypervisors 205a-205e. The results of the verification may lead to further actions for each hypervisor and compiled for users to review. For example, for each verification, the hypervisor status check 420 may determine that a hypervisor is not operating properly (e.g., “Bad” status report). Upon receiving the negative checking result, the hypervisor management system 400 executes a hypervisor repair procedure 430 and attempt to resolve the operation issues detected. For example, the repair procedure may include resetting one or more virtual machines and/or resource allocations in the hypervisor.

In some cases, the hypervisor repair procedure 430 may not be able to resolve the operation problems in the hypervisor, and marks the hypervisor 432 with the irreparable result (e.g., marking the hypervisor “bad”). On the other hand, when the hypervisor repair procedure 430 has successfully resolved the issue, another verification hypervisor status check 420 will be performed on the hypervisor. In some cases, the hypervisor repair procedure 430 may access or review previous repair attempts to determine whether a hypervisor is reparable (e.g., to exit the loop of repairing attempts if the hypervisor status check 420 continues to return negative results).

When the hypervisor status check 420 returns positive results, indicating the hypervisor is operating as expected, the hypervisor information 422 will be collected and cross-checked with the information on record. If the information matches, the hypervisors management system 400 then marks 424 the verified hypervisor “good.” If the information does not match (e.g., due to repairment and/or resource allocation updates), the hypervisor information on record will be updated and the new/updated hypervisor information is printed 426 for user review. As such, on the user side, efforts for management of multiple hypervisors is reduced to reviewing results (including markings of bad hypervisors and the updated hypervisor information if repairment is performed).

In some cases, the hypervisor status check 420 may further include virtual machine (VM) status check 440 when the hypervisor is operating properly (e.g., status being “good”). For example, the hypervisors management system 400 performs VM status check 440 on each VM in the corresponding hypervisor. When the VM status check 440 indicates that a VM is not operating properly, the hypervisors management system 400 executes a VM repair procedure 450. In some cases, the VM repair procedure 450 may not be able to resolve the operation problems in the VM, and marks the VM 452 with the irreparable result (e.g., marking the VM “bad”). In some cases, when the VM repair procedure 450 has successfully resolved the issue of the VM, another VM status check 440 will be performed on the repaired VM. In some cases, the VM repair procedure 450 may access or review previous repair attempts to determine whether a VM is reparable.

When the VM status check 440 returns positive results, indicating the VM is operating as expected, the VM information 442 will be collected and cross-checked with the information on record. If the information matches, the hypervisors management system 400 then marks 444 the verified VM(s) “good.” If the information does not match (e.g., due to repairment and/or resource allocation updates), the VM information on record will be updated and the new/updated VM information is printed 446 for user review. As such, on the user side, a granular review of the VMs operating across multiple hypervisors is achieved by automatically collecting the VM markings (e.g., bad or good) and updates of VM information.

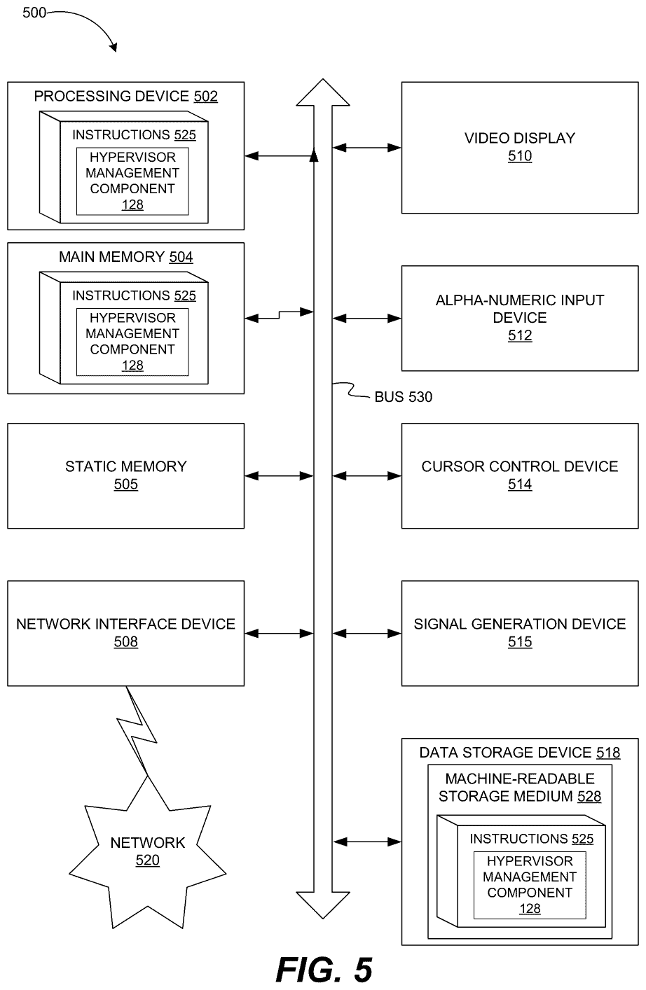

FIG. 5 is a block diagram of an example computing device 500 that may perform one or more of the operations described herein, in accordance with some embodiments. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 500 may include a processing device (e.g., a general purpose processor, a PLD, etc.) 502, a main memory 504 (e.g., synchronous dynamic random access memory (DRAM), read-only memory (ROM)), a static memory 505 (e.g., flash memory and a data storage device 518), which may communicate with each other via a bus 530.

Processing device 502 may be provided by one or more general-purpose processing devices such as a microprocessor, central processing unit, or the like. In an illustrative example, processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also include one or more special-purpose processing devices such as an application specific integrated circuit (ASIC), a field programmable gate array (FPGA), a digital signal processor (DSP), network processor, or the like. The processing device 502 may be configured to execute the operations described herein, in accordance with one or more aspects of the present disclosure, for performing the operations and steps discussed herein.

Computing device 500 may further include a network interface device 508 which may communicate with a network 520. The computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 515 (e.g., a speaker). In one embodiment, video display unit 510, alphanumeric input device 512, and cursor control device 514 may be combined into a single component or device (e.g., an LCD touch screen).

Data storage device 518 may include a computer-readable storage medium 528 on which may be stored one or more sets of instructions 525 that may include instructions for a testing suite 232 of the hypervisor test and efficiency manager 230 component, e.g., the hypervisor management component 128 for carrying out the operations described herein, in accordance with one or more aspects of the present disclosure. Instructions 525 may also reside, completely or at least partially, within main memory 504 and/or within processing device 502 during execution thereof by computing device 500, main memory 504 and processing device 502 also constituting computer-readable media. The instructions 525 may further be transmitted or received over a network 520 via network interface device 508.

While computer-readable storage medium 528 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

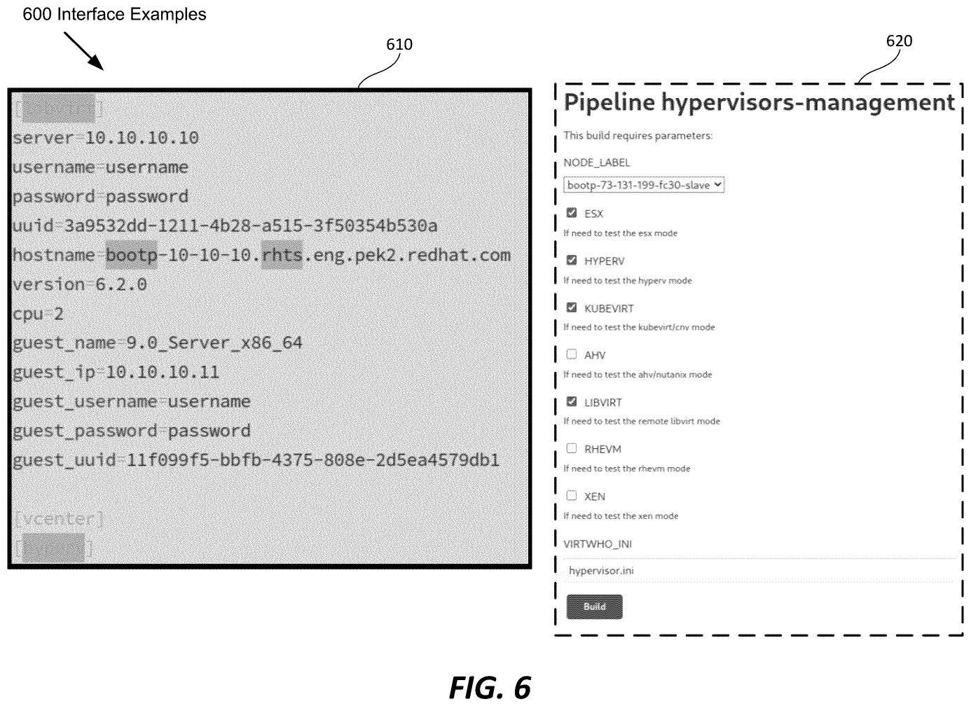

FIG. 6 illustrates example interfaces 600 for managing hypervisor efficiency and uptime, in accordance with some embodiments of the present disclosure. An example initiation code is illustrated in the window 610, which includes instructions or identifications for a hypervisor and the virtual machines (e.g., a guest) therein for executing the test suites mentioned above. In some cases, the example code may be executed as a Jenkins pipeline job. For example, multiple backend codes may be used to provide the necessary functions and interfaces for each of the various hypervisors and VMs therein. A data file is generated to collect key information indicating the performance of the hypervisors and VMs (e.g., a summary of operation status, updates or changes, as discussed in relation to FIG. 4).

The backend codes may include, as illustrated in FIG. 6, login access information as well as values of configurations to be tested or updated, such as the values indicated by the hypervisors.json or hypervisors.ini as shown in the window 620. The window 620 also illustrates options for selecting which hypervisors may run the test suite. As discussed in relation to the start module 405 of FIG. 4, the start and/or termination of the automatic verification may be configured by setting a periodic interval or upon satisfaction of triggering conditions (including detecting updates, timer expiration, etc.).

In some cases, to initiate a verification procedure, the hypervisors management system may check the status report of the hypervisor and the VMs therein. The checking may also be performed by accessing respective hypervisors and the VMs therein to run commands or run APIs to see if the response indicates proper operations.

In some cases, the hypervisors management system executes the automatic verification procedure together with resource consumption management (e.g., checking whether a hypervisor is idling if the VMs therein are not performing substantial jobs). When a hypervisor falls below certain operation threshold and is determined to be idling, even if the hypervisor is operating properly (e.g., passing the testing suite), the hypervisors management system may nonetheless terminate or shutdown the VMs and the hypervisor to free up the hardware resources assigned. This way, the freed-up resources may be reassigned to other hypervisors that are underperforming due to a lack of resource allocation.

Unless specifically stated otherwise, terms such as “receiving,” “routing,” “updating,” “providing,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method of verifying operational status of a plurality of hypervisors, the method comprising:
executing, by a processing device, respective diagnostic applications in the plurality of hypervisors;
collecting, from the plurality of hypervisors, a plurality of status reports for the plurality of hypervisors, wherein each of the plurality of status reports indicates whether a corresponding hypervisor is operating properly;
grouping a first subset of the plurality of status reports corresponding to proper operations and collecting hypervisor information of the first subset of the plurality of status reports;
grouping a second subset of the plurality of status reports corresponding to improper operations and executing respective repair applications in corresponding hypervisors associated with the second subset of the plurality of status reports; and
generating, by the processing device, a report summarizing the hypervisor information of the first subset of the plurality of status reports and repairment status of the corresponding hypervisors associated with the second subset of the plurality of status reports.

2. The method of claim 1, wherein executing, by the processing device, the respective diagnostic applications in the plurality of hypervisors comprises at least one of:
periodically executing the respective diagnostic applications in the plurality of hypervisors at a time interval; or
executing, in response to a trigger condition being satisfied, the respective diagnostic applications in the plurality of hypervisors, wherein the trigger condition comprises detecting, by the processing device, that a virtual machine of the plurality of hypervisors has hung.

3. The method of claim 2, wherein grouping the first subset of the plurality of status reports corresponding to proper operations and collecting hypervisor information of the first subset of the plurality of status reports comprise:
placing an indicator in each hypervisor corresponding to the first subset of the plurality of status reports of proper operations; and
printing, with the indicator for each hypervisor in the generated report, the collected hypervisor information of the first subset of the plurality of status reports.

4. The method of claim 3, further comprising:
evaluating status for a plurality of virtual machines running in the plurality of hypervisors;
collecting, from the plurality of virtual machines, a plurality of virtual-machine (VM) status reports for the plurality of virtual machines, wherein each of the plurality of VM status reports indicates whether a corresponding virtual machine is operating properly;
grouping a third subset of the plurality of VM status reports corresponding to proper VM operations and collecting VM information of the third subset of the plurality of VM status reports;
grouping a fourth subset of the plurality of VM status reports corresponding to improper operations and executing respective repair applications in corresponding virtual machines associated with the fourth subset of VM status reports; and
generating, by the processing device in the report, a VM summary of the VM information of the third subset of the plurality of VM status reports and repairment status of the corresponding virtual machines associated with the fourth subset of VM status reports.

5. The method of claim 4, wherein the repairment status of the corresponding virtual machines comprise identifications of irreparable virtual machines.

6. The method of claim 4, wherein the VM summary of the VM information of the third subset of the plurality of VM status reports comprises:
resources occupied by properly operating virtual machines of the plurality of hypervisors; and
identifications of the properly operating virtual machines of the plurality of hypervisors.

7. The method of claim 6, further comprising:
disabling one or more hypervisors in the plurality of hypervisors based on the resources occupied by the properly operating virtual machines; or
creating one or more hypervisors in the plurality of hypervisors based on the resources occupied by the properly operating virtual machines.

8. The method of claim 2, wherein grouping the second subset of the plurality of status reports corresponding to improper operations and executing respective repair applications in corresponding hypervisors associated with the second subset of the plurality of status reports comprise:
determining one or more hypervisors having executed respective repair applications to be irreparable; and
removing the one or more irreparable hypervisors from the plurality of hypervisors.

9. The method of claim 1, wherein the plurality of hypervisors comprises hypervisors belonging to various servers.

10. An apparatus for verifying operational status of a plurality of hypervisors, the apparatus comprising:
a memory; and
a processing device coupled to the memory, the processing device and the memory to:
execute respective diagnostic applications in the plurality of hypervisors;
collect, from the plurality of hypervisors, a plurality of status reports for the plurality of hypervisors, wherein each of the plurality of status reports indicates whether a corresponding hypervisor is operating properly;
group a first subset of the plurality of status reports corresponding to proper operations and collecting hypervisor information of the first subset of the plurality of status reports;
group a second subset of the plurality of status reports corresponding to improper operations and executing respective repair applications in corresponding hypervisors associated with the second subset of the plurality of status reports; and
generate a report summarizing the hypervisor information of the first subset of the plurality of status reports and repairment status of the corresponding hypervisors associated with the second subset of the plurality of status reports.

11. The apparatus of claim 10, wherein the processing device and the memory are to execute the respective diagnostic applications in the plurality of hypervisors by performing at least one of:
periodically executing the respective diagnostic applications in the plurality of hypervisors at a time interval; or
executing, in response to a trigger condition being satisfied, the respective diagnostic applications in the plurality of hypervisors, wherein the trigger condition comprises detecting that a virtual machine of the plurality of hypervisors has hung.

12. The apparatus of claim 11, wherein the processing device and the memory are to group the first subset of the plurality of status reports corresponding to proper operations and collecting hypervisor information of the first subset of the plurality of status reports by:
placing an indicator in each hypervisor corresponding to the first subset of the plurality of status reports of proper operations; and
printing, with the indicator for each hypervisor in the generated report, the collected hypervisor information of the first subset of the plurality of status reports.

13. The apparatus of claim 12, wherein the processing device and the memory are further to:
evaluate status for a plurality of virtual machines running in the plurality of hypervisors;
collect, from the plurality of virtual machines, a plurality of virtual-machine (VM) status reports for the plurality of virtual machines, wherein each of the plurality of VM status reports indicates whether a corresponding virtual machine is operating properly;
group a third subset of the plurality of VM status reports corresponding to proper VM operations and collecting VM information of the third subset of the plurality of VM status reports;
group a fourth subset of the plurality of VM status reports corresponding to improper operations and executing respective repair applications in corresponding virtual machines associated with the fourth subset of VM status reports; and
generate, in the report, a VM summary of the VM information of the third subset of the plurality of VM status reports and repairment status of the corresponding virtual machines associated with the fourth subset of VM status reports.

14. The apparatus of claim 13, wherein the repairment status of the corresponding virtual machines comprise identifications of irreparable virtual machines.

15. The apparatus of claim 13, wherein the VM summary of the VM information of the third subset of the plurality of VM status reports comprises:
resources occupied by properly operating virtual machines of the plurality of hypervisors; and
identifications of the properly operating virtual machines of the plurality of hypervisors.

16. The apparatus of claim 15, wherein the processing device and the memory are further to:
disabling one or more hypervisors in the plurality of hypervisors based on the resources occupied by the properly operating virtual machines; or
creating one or more hypervisors in the plurality of hypervisors based on the resources occupied by the properly operating virtual machines.

17. The apparatus of claim 11, wherein the processing device and the memory are to group the second subset of the plurality of status reports corresponding to improper operations and executing respective repair applications in corresponding hypervisors associated with the second subset of the plurality of status reports by:
determining one or more hypervisors having executed respective repair applications to be irreparable; and
removing the one or more irreparable hypervisors from the plurality of hypervisors.

18. A non-transitory computer-readable storage medium having instructions stored thereon that, when executed by a processing device for verifying operational status of a plurality of hypervisors, cause the processing device to:
execute respective diagnostic applications in the plurality of hypervisors;
collect, from the plurality of hypervisors, a plurality of status reports for the plurality of hypervisors, wherein each of the plurality of status reports indicates whether a corresponding hypervisor is operating properly;
group a first subset of the plurality of status reports corresponding to proper operations and collecting hypervisor information of the first subset of the plurality of status reports;
group a second subset of the plurality of status reports corresponding to improper operations and executing respective repair applications in corresponding hypervisors associated with the second subset of the plurality of status reports; and
generate a report summarizing the hypervisor information of the first subset of the plurality of status reports and repairment status of the corresponding hypervisors associated with the second subset of the plurality of status reports.

19. The non-transitory computer-readable storage medium of claim 18, wherein to execute the respective diagnostic applications in the plurality of hypervisors is to perform at least one of:
periodically executing the respective diagnostic applications in the plurality of hypervisors at a time interval; or
executing, in response to a trigger condition being satisfied, the respective diagnostic applications in the plurality of hypervisors, wherein the trigger condition comprises detecting that a virtual machine of the plurality of hypervisors has hung.

20. The non-transitory computer-readable storage medium of claim 19, wherein to group the first subset of the plurality of status reports corresponding to proper operations and collecting hypervisor information of the first subset of the plurality of status reports is to:
place an indicator in each hypervisor corresponding to the first subset of the plurality of status reports of proper operations; and
print, with the indicator for each hypervisor in the generated report, the collected hypervisor information of the first subset of the plurality of status reports.
